(19) United States
(12) Patent Application Publication
(10) Pub. No.: US 2010/0203863 A1
(43) Pub. Date: Aug. 12, 2010

(54) METHOD OF ENABLING OPERATORS TO ALLOW THEIR CUSTOMERS TO CHOOSE BETWEEN CALLING-PARTY-PAYS AND RECEIVING-PARTY-PAYS ON INCOMING CALLS

(76) Inventors: Nir Kapelushnik, Raanana (IL); Bartal Ronen, Avihail (IL); Ehud Amir, Ramat Hasharon (IL)

Correspondence Address: GREENBERG TRAURIG, LLP (DC/ORL), 2101 L Street, N.W., Suite 1000, Washington, DC, 20037, US

(21) Appl. No.: 12/683,764

(22) Filed: Jan. 7, 2010

Related U.S. Application Data
(60) Provisional application No. 61/283,683, filed on Dec. 8, 2009.

(51) Int. Cl. H04M 11/00

(52) U.S. Cl. 455/406

(57) ABSTRACT

A system and methods are described which enable cellular operators to implement the Calling Party Pays (“CPP”) approach for roaming charges. Mobile Service Providers are enabled to allow their roaming customers to choose between the CPP approach and the Receiving Party Pays (“RPP”) approach on specific incoming roaming calls. Before a call from an originating caller to a Roaming customer is connected, a party is advised of the charge that he will incur by virtue of the Roaming customer being outside his cellular local network, and is given an opportunity to accept the charge. In addition, roaming customers may determine the charge a specific caller will pay for a call.

This application claims priority to U.S. Provisional Application Ser. No. 61/283,683 filed on Dec. 8, 2009, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of wireless services that incur roaming and other charges, and in particular to cellular phone services which charge roaming rates when the roaming customers travel outside of the coverage area of their cellular local network.

### BACKGROUND OF THE INVENTION

Cellular operators and or service providers (“Mobile Service Providers”) generally operate their own cellular network (“Cellular Local Network”), and provide their customers with cellular service throughout the Cellular Local Network at contractual rates that may include a monthly allocation of minutes to use, or a per-minute charge, or a combination of the two.

A telephone connection to a mobile phone serviced by a Mobile Service Provider comprises two legs. The first leg is the portion of the connection extending from the originating device through one or more gateways/switches (the “Originating Leg”). The second leg is the portion of the connection extending from a gateway/switch to the mobile phone (the “Receiving Leg”). While the charges associated with the Originating Leg typically are the responsibility of the originating caller, there are generally two methods of charging for the Receiving Leg, namely: charge the receiver of the call (the “Receiving Party Pays” or “RPP” approach) or do not charge the receiver of the call (the “Calling Party Pays” or “CPP” approach). Under the RPP approach, the receiving party may pay a per-minute charge for incoming calls, or may have a monthly allocation, after which a per minute charge applies.

In some countries, including the United States, the minute-based allocations and/or charges for the Receiving Leg of cellular services within the Cellular Local Network may apply to the customer regardless of whether the call is incoming or outgoing—this is known as the RPP approach. In most countries, however, the minute-based allocations and/or charges for the Receiving Leg of cellular services within the Cellular Local Network typically apply to the customer only for outgoing calls—this is referred the CPP approach. Accordingly, in most countries when a Mobile Service Provider's customer is within Cellular Local Network coverage, the Receiving Leg charges for an incoming call are free of charge to the call recipient, and such charges may be charged to the call originator.

When a Mobile Service Provider's customer travels outside the Cellular Local Network coverage area (“Roaming”), however, the Receiving Leg charges for an incoming call are generally charged to the call receiver in accordance with the RPP approach. Although the originating device may be charged for the Originating Leg of the connection, which may include long-distance rates, Roaming charges for incoming calls are associated with the Receiving Leg. Roaming charges are almost universally billed to the call receiver at a higher per-minute rate than charges for calls made within the Cellular Local Network. The Roaming charges may depend in part upon agreements between the customer's Mobile Service Provider and various third party mobile service providers. Moreover, although they may be charged by third party mobile service providers, Roaming charges are generally presented to the Roaming customer on their own Mobile Service Provider's phone bill.

When a Mobile Service Provider's customer is roaming, they are sometimes aware of the Roaming charges they will be charged for cellular use under the RPP approach. Even though Roaming charges may be determinable in advance, frequently if a Roaming customer has not traveled to an area before, they are not aware of the charges they will incur for phone use. Largely because of this issue, many Roaming customers block the option of receiving calls while Roaming, or simply do not answer (accept the call) while Roaming.

In some service plans, there is an option for a Roaming customer to set a PIN code in order to allow calls only from originators that have the PIN code. This may help in preventing unwanted callers from being able to reach the customer. Frequently, however, Roaming customers (for example, business travelers), will give their PIN to most of their business associates, reducing the practical effectiveness of this method of reducing calls and calls charges. If a call reaches a Roaming customer, the customer may recognize caller's ID and the Roaming customer can elect whether or not to answer the call, and thus whether or not to incur the potentially unknown and generally high Roaming charge.

### BRIEF DESCRIPTION OF THE DRAWINGS

FIG. 1(a) shows an illustration of connections between the Roaming customer's mobile telephony device and an originating telephony device via a Mobile Service Providers' network in accordance with embodiments of the invention.

FIG. 1(b) shows an illustration of a contact entry with a service level stored in an address book in accordance with embodiments of the invention.

FIG. 2 shows an illustration of a method and procedure for the Roaming customer to set the RPP List in accordance with embodiments of the invention.

FIG. 3 shows an illustration of a method and algorithm used by the Mobile Service Provider to allow either the RPP or the CPP approach for Roaming customers in accordance with certain embodiments of the invention.

FIG. 4 shows an illustration of a method and procedure for the Roaming customer to select the service level for specific parties in accordance with certain embodiments of the invention.

### DETAILED DESCRIPTION OF EMBODIMENTS OF THE INVENTION

New systems and methods for enabling Mobile Service Providers to allow their customers to choose between the CPP approach and the RPP approach on incoming calls, regardless of the Roaming status of the customer device, are described herein. In an embodiment, the charges relating to Roaming services are billed to the call originator, as with the CPP approach, rather than billing the receiver of the call according to the RPP approach.

In addition, new systems and methods for managing Roaming charges of telephone calls made or received while a Roaming customer is outside of the Cellular Local Network are described. In an embodiment, a Roaming customer sets a list of contacts or numbers for which the Roaming customer will bear the charges of the calls made from these contacts or numbers, or characteristics of the contacts or numbers, e.g., area codes, country codes or search strings with regular search terms (“RPP List”). The RPP List may be left empty. For other incoming calls, charges are billed to the call originator in accordance to the CPP approach, upon the originator's acceptance. When presented with an option to accept the relevant charge, the originator may either complete the call and bear the charges or terminate the call without incurring charges. The RPP List may be set through an Interactive Voice Response (“IVR”), an Internet website, a call center representative, text messaging, email or other means of communicating the required information. A system implementing the present invention may include a call transition module. The call transition module is adapted to permit the connection between the originating device and the mobile device if the originating device is identified on the RPP List.

The system and method may be implemented wholly or partially in the operator's Intelligent Network system (“IN System”) or at other components of the Mobile Service Providers' network. In an embodiment, the IN System has the capability to recognize whether the originating caller is on the RPP List. In an embodiment, recognition is implemented at some component on the Mobile Service Providers' network other than the IN System, or by a third party entity. While embodiments discussed herein describe an IN System performing certain functions concerning the invention, these functions need not be handled by the IN System at all, as will be readily understood by those skilled in the art.

Where the originating caller is not on the RPP List, before a call to a Roaming customer is connected, the originating caller is requested to accept the charge that would be incurred as a result of the call—and may be advised of the basis of such charges, e.g., the per-minute rate. Typically, the charges that would be incurred as a result of such a call include the charges for the customer (not the call originator) Roaming outside her/his Cellular Local Network. The call originator is given an opportunity to accept or reject the charge. If the originating caller accepts the obligation to pay for the charges, the call will be connected to the Roaming customer and the originating caller will be billed for the Roaming customer's charges in addition to such other charges as the originating caller may otherwise be obligated to pay. Where the charges are not accepted, the call may be terminated. In an embodiment, where the charges are not accepted, the called party is provided the option of paying for the Roaming charges. In another embodiment, where the charges are not accepted, the called party is provided the option of paying for the Roaming charges. Thus, if an originating caller is not on the RPP List, the originating caller is presented the option of accepting the Roaming charges; in the event the originating caller declines the charges, the call may still be connected if the called party accepts the Roaming charges.

In an embodiment, a “Pass List” provides a list of contacts or numbers, or of characteristics of contacts or numbers (e.g., area codes, country codes or search strings with regular search terms), for which the customer will accept calls where the originating party declines to do so. In an embodiment, the Pass List is accessible to the customer in a manner similar the RPP List. Thus, if an originating caller is not on the RPP List, the originating caller is presented the option of accepting the Roaming charges; in the event an originating caller on the Pass List declines the charges, the call may still be connected with the Roaming charges being borne by the called party.

In an embodiment, this method may also be implemented within a network as follows. The network receives a request for an originating telephony device to connect with a mobile telephony device. A determination may be made of the charge required to permit the originating device to connect with the mobile telephony device. A request to accept that charge is transmitted from the network to one or more telephony devices and, if the network receives an acceptance of the charge, the connection between the originating telephony device and the mobile telephony device is completed. The charge is then charged to an account associated with the accepting device, typically the originating telephony device.

In an embodiment, the Roaming customer is provided with the charges associated with a telephone call, and given a choice of rates available from various network providers so that he can select the least expensive network while Roaming. The Roaming customer can be provided with different rates for the different phone numbers with which the Roaming customer connects, i.e., different numbers in his address book. The determination of network providers for Roaming service may be based on other factors, including the identification of the service provider of the party with whom the Roaming customer connects. For example, for calls to a particular contact in the Roaming customer's address book the Roaming customer may choose the same network as that of the contact in order to minimize the number of networks utilized during a connection and thereby minimize the rate for such a call. Alternatively, the Roaming customer may choose a preferred service provider for a contact in his address book based on the sound quality of the connection to be provided, as predetermined by the user.

Reference will now be made to embodiments of the present invention with reference to the accompanying drawings. Each block of the block diagrams or operational illustrations, and combinations of blocks in the block diagrams or operational illustrations, may be implemented by means of analog or digital hardware and computer programmed instructions. Computer programmed instructions may be provided to a processor of a general purpose computer, special purpose computer, ASIC, or other programmable data processing apparatus, such that the instructions, which execute via the processor of the computer or other programmable data processing apparatus, implements the functions/acts specified in the all or part of a block of the block diagrams or a combination of all or part of multiple blocks of the block diagrams. The illustrations are not meant to implicate a temporal order other than as necessary to carry out the functions or acts noted in the blocks. Thus, for example, where two blocks are shown in succession, the functions or acts represented thereby may be executed substantially concurrently or in the reverse order, depending upon the functionality/acts involved.

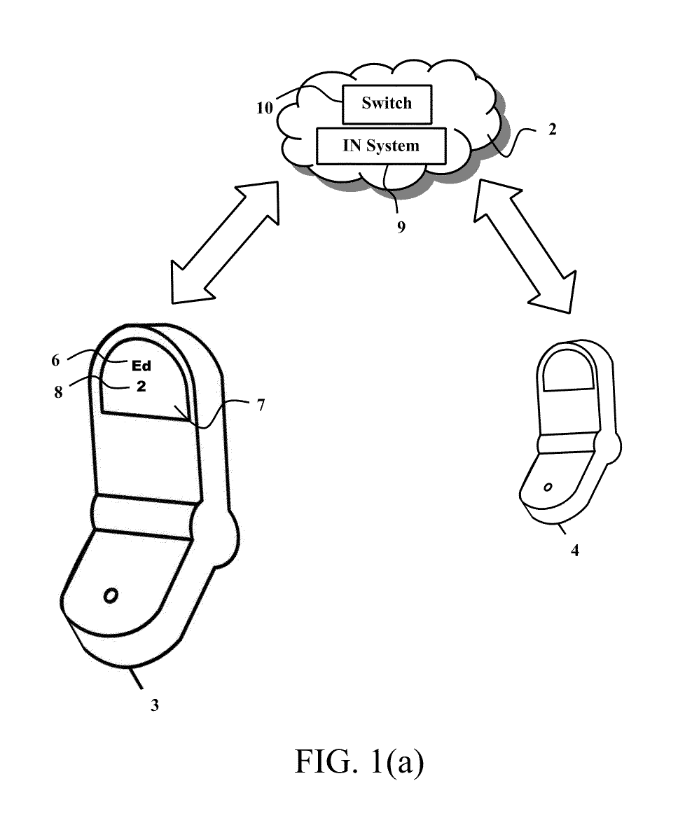

With reference to FIG. 1(a), pursuant to a contract between a customer and a Mobile Service Provider 2, the customer agrees to pay a predetermined rate for connecting through the Cellular Local Network of the Mobile Service Provider 2 via a customer's telephony or network receiving device 3. Generally, the customer's receiving device 3 is a portable device that allows the customer to communicate with an originating telephony devices 4 associated or owned by third parties that are, generally, the customer's contacts.

The customer's receiving device 3 may be a mobile device including, but not limited to, a cellular telephone, laptop, personal digital assistant, or smart phone. Similarly, the originating telephony device 4 may also be a mobile device, such as a cellular telephone, laptop, personal digital assistant, or smart phone, or may be a telephony device associated with a landline. In an embodiment, the Mobile Service Provider 2 may comprise a switch 10 and an Intelligent Network system (“IN System”) 9.

FIG. 1(a) further shows that service level information 8, reflecting the quality or type of service, may also be provided before the customer's receiving device 3 and the originating telephony device 4 connect to one another. In an embodiment, service level information 8 is provided while the connection is pending, e.g., while the line is still ringing. In an embodiment, service level information 8 is provided before the connection is attempted. In an embodiment, the service level information 8 and contact information 6 (the latter including, e.g., caller ID or other identification of the remote party to the call) may be displayed on the customer's receiving device 3 or on the originating telephony device 4, or on both. The contact information 6 and the service level information 8 may be stored in an address book 7. In an embodiment, the address book 7 is stored in the customer's receiving device 3. In an embodiment (not shown), the address book is stored by the service provider.

In an embodiment, the customer's receiving device 3, the originating telephony device 4, or both, can be provided an indication of the charge or charge rate for the Receiving Leg of the telephone call. Accordingly, it is within the scope of the present invention that either may decide to accept the charges for the Receiving Leg in order to continue with the telephone call. If neither will accept the charges, the service provider may terminate the call.

While Roaming, the customer may be given a choice of networks that are operated by various service providers. The prevailing rates for calls placed over the different networks may vary. While the Roaming customer may prefer one network over another, the Roaming customer may choose the service level information 8 that is associated with lowest cost per minute for Roaming calls. Because the service level information 8 is predetermined by agreements between the service providers, the service level information 8 may be provided to the Roaming customer.

Accordingly, the Roaming customer can choose the service level information 8 for telephone calls while Roaming. Furthermore, the Roaming customer may assign particular service levels information 8 for each contact entry in an address book 7. The contact information 6 and the service level information 8 may be stored in an address book 7, which may be stored in the customer's receiving device 3. FIG. 1(b) shows contact information, service level information, and the Roaming charge that is associated with a contact entry.

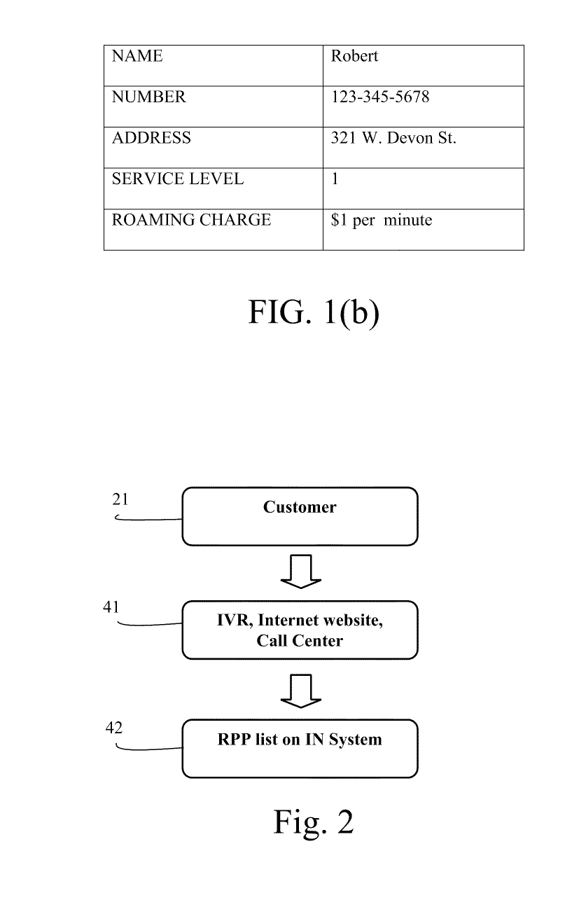

As illustrated in FIG. 2, in an embodiment, a customer 21 may provide an RPP List 42. The RPP List 42 represents the contacts, numbers or search expressions for contacts or numbers (collectively, “RPP Contacts”), for which the customer 21 is willing to pay for Roaming charges associated with the Receiving Leg incurred as a result of incoming calls originated by those RPP Contacts. The RPP List 42 may be created in the IN System (or in a location accessible to the IN System) while the customer's receiving device is in the Cellular Local Network or when the customer is Roaming. In an embodiment, the customer 21 may add or delete RPP Contacts from the RPP List 42 via various means 41, such as IVR, an Internet website, Internet websites, a call center representative, text messaging, email or other means of communicating the required information.

In an embodiment, the customer 21 stores the RPP Contacts in the RPP List 42 on the customer's device's memory, on the customer's device's Subscriber Identity Module (“SIM”) card, or on another storage device. In an embodiment, the RPP Contacts in the RPP List 42 may be sent to the Mobile Service Provider by text message (a.k.a. “Short Message Service”) or any other communication method that can communicate the contents of the Contacts.

In some countries, the originator of a call incurs a charge for the Receiving Leg of a telephone connection made within the Cellular Local Network. In some countries, the customer 21 may, when in the Cellular Local Network, incur a standard rate charge for the Receiving Leg of the telephone connection pursuant to the customer's contract with a service provider. When outside the Cellular Local Network, a Roaming rate charge may be included in the charge, which is typically billed to the customer 21. The service provider transporting the Roaming customer's call while the customer 21 is outside of the Cellular Local Network, however, can request that the call originator accept the Roaming charges associated with the call. The Roaming rate charge may be determined pursuant to the service level agreements between the customer and its Cellular Local Network or agreements between its Cellular Local Network and other service providers, or otherwise. Regardless of how the Roaming rate charge is determined, where the service provider transporting a Roaming customer's call can determine the charge for the call, in an embodiment, the service provider's request to the call originator to accept the Roaming charges may be accompanied by an identification of the charges or the basis for the charges.

In a system implementing the present invention, an identification of the charge required for the connection between an originating device and a mobile device can be determined by a charge determiner. In a embodiment, the charge determiner would determine only the portion of the charge that is associated with the Roaming status of the mobile device. In an embodiment, a charge determiner can be used to quantify only the mobile device Roaming charge for a connection between an originating device and a mobile device; in such embodiment, the mobile device Roaming charge may be that charge associated only with the mobile device being located outside its cellular local network.

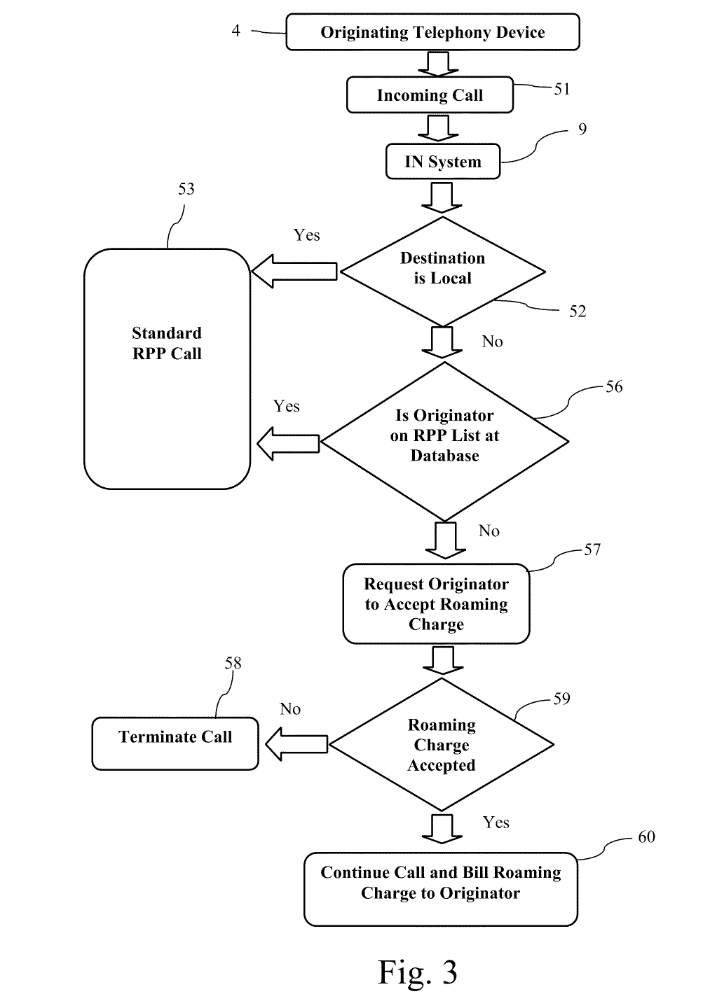

FIG. 3 describes an embodiment of the present invention that enables a telephone service to allow CPP charges for the Receiving Leg on Roaming calls. In an embodiment, when the originating telephony device 4 initiates a call to a customer's receiving device, the incoming call 51 is detected at the IN System 9 or by other systems as is known in the art. Components of the service providers' network, such as, for example, the IN System 9, may determine whether the Roaming device is in its Cellular Local Network or Roaming, at step 52. If the roaming device is in the Cellular Local Network, the call may be connected and billed as a Standard RPP Call 53. If the customer's receiving device is Roaming outside its Cellular Local Network, in an embodiment, at step 56, a determination will be made as to whether or not the originating telephony device 4 is in an RPP List, and if it is, the service provider can bill the call charge to the Roaming device as a standard RPP Call 53. In a system implementing the present invention, a biller can be used to direct the charge the Roaming charges for the Roaming device to the originating device or to another person or device accepting the charge. In an embodiment, the charge would be appear on an invoice for the account associated with the originating device, and associated with the phone number of the originating device.

If the originating telephony device 4 is not in an RPP List, in an embodiment, a service provider may provide a request to the originating telephony device 4 to accept the Roaming charge, at step 57. In an embodiment, the request may: indicate that the Roaming device is not in its Cellular Local Network; and/or provide the charge rate or charge for the call. If the originating telephony device 4 accepts responsibility for the charges, at step 59, the service provider may connect the originating telephony device 4 to the customer's receiving device and may bill the Roaming charges 60 to the originating telephony device 4. If the originating telephony device 4 rejects the charges, a service provider may terminate the call 58. In an embodiment, where the charges are not accepted by the originating telephony device 4, the customer's receiving device may be provided the option of paying for the Roaming charges. In an embodiment, where the charges are not accepted by the originating telephony device 4, a prompt may be presented at the customer's receiving device providing the option of paying for the Roaming charges. Thus, if an originating caller is not on the RPP List, the originating caller is presented the option of accepting the Roaming charges; in the event the originating caller declines the charges, the call may still be connected if the called party accepts the Roaming charges. In an embodiment, the called party could, in advance, elect to receive calls that the originating caller declines to pay. In a system implementing the invention, a presenter can be used to transmit a request, or to present a request, to the originating device, seeking to obtain authorization for that device to incur a charge. The presenter can also be used to receive a response to that request. In an embodiment, the request to incur a charge may include an indicia of the charge, including, for example, the charge rate.

In an embodiment, the request to incur a charge may be for a predetermined charge, such as a rate set by the mobile device user. This charge may, or may not be related to the Roaming charges associated with the call. Such a predetermined charge could be fixed for calls to a particular mobile device, regardless of its Roaming status, or could be associated with the originating device.

In an embodiment, a service provider may provide a customer with the ability to have a charge rate for incoming calls to the customer's receiving device from any originating device or from a specific list of originating devices, even when in the customer's receiving device is in the Cellular Local Network. In an embodiment, the IN System 9 may handle the transaction, as above, by providing a request to the originating telephony device 4 to accept a charge or charge rate in consideration of connecting the call. In an embodiment, the request to accept charges is provided only to originating telephony devices that are not reflected in the RPP List. Thus, the service provider enables customers to charge call originators for incoming calls to the customer's receiving device. The charge or charge rate may be higher than the call charge. The ability to charge a charge rate for an incoming call to a call originator can be used by a party providing services, such as, for example, consulting, entertainment, or information services.

According to some embodiments, when the originating device 4 initiates a telephone call, the IN system 9 may determine whether the call is a standard call, which is within the home network, or a Roaming call. If the telephone call is a standard call, then there may be no action taken other than to connect the call. If the telephone call is a Roaming call, then a service provider may check which service level is associated with the originating device 4 and provide the originating device 4 with the determined service level. If the originating device 4 does not accept the telephone call, the call is terminated. If the originating device 4 accepts the service level, then the telephone call is continued. The service provider may also provide billing information.

While embodiments discussed above describe the IN System handling the transaction by providing a request to the originating telephony device or determining whether a call is a standard call, or other functions, these functions need not be handled by the IN System at all, as will be readily understood by those skilled in the art.

In a system implementing the invention the device that will indicate acceptance of the charges—that is, for example, the obligation to pay the charges presented by a presenter—can send an indication of the acceptance of the charges across the network such that the network thereafter establish a connection between the originating device and the mobile device. Such a charge acceptor can be part of the IN System, or, for example, can be external to the network. In an embodiment, an application operating on a smart phone may include software to request a determination of the cost of a call, and thereafter, in connection with a attempting to place a call, can transmit an acceptance of the charge. In this manner, as an example, both the presenter and the charge acceptor can operate on a device outside the network.

When traveling abroad, a roaming customer may not have the choice of determining the foreign telephone network or operator that is used to carry a telephone call. When a choice of carriers or operators is available in a given location, the rates charged may vary according to a mix of factors, such as contractual deals with the user's employment; the cost per-minute for the telephone call; and/or the bandwidth or sound quality of the telephone call. Accordingly, the Roaming customer may decide on which network carrier or operator may transport his or her telephone calls based on such factors, including: any contractual deals with the user's employment; the cost per-minute for the telephone call; and/or the bandwidth or sound quality of the telephone call.

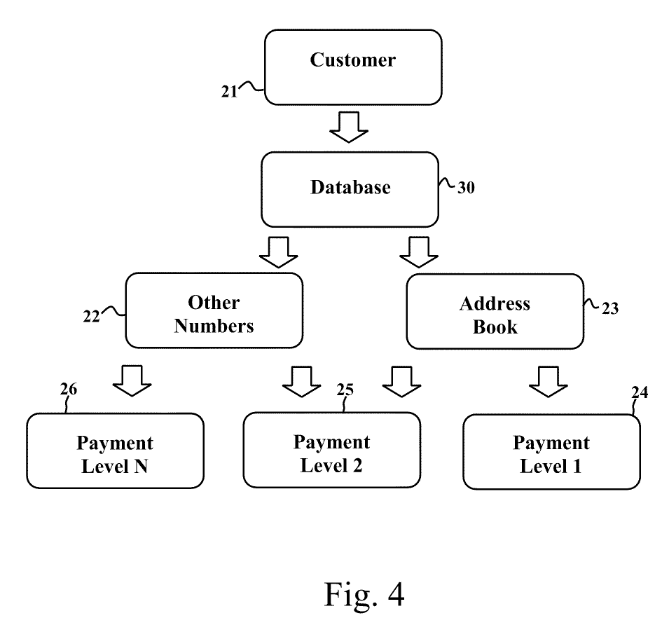

As illustrated in FIG. 4, in an embodiment, the disclosed system and method include a customer 21 who sets up service levels 24-26 for telephone calls made while Roaming. The customer 21 can access a local or remote database 30, and within that database 30, the customer 21 can access its address book 23 in order to associate each entry or group of entries with a relevant service level 24-26. The Roaming customer 21 may also define a specific default service level 24-26 for other telephones numbers 22 not in the address book 23.

The service levels 24-26 may be in accordance with the RPP approach, the CPP approach, or any combination of the two approaches. In an embodiment, the Roaming customer 21 may select only two groups. One group is allowed to call and the mode will be in accordance with the RPP approach, while the other group will be assigned to the mode in accordance with the CPP approach.

In an embodiment, the method comprises billing an originating caller for a portion of a cost of the connection, where: (i) the customer determines the portion of the cost of the Receiving Leg of the Roaming connection that is billed to the originating caller; and (ii) the originating caller accepts the obligation to pay the portion of the charges for the Receiving Leg of the telephone connection.

In an embodiment, the entries in the RPP List are associated with a maximum charge or charge rate for the Receiving Leg of telephone connection that will be permitted. In such embodiment, where an originating device 4 initiates a call to a customer's receiving device, where the charge or charge rate for the Receiving Leg exceeds the maximum, the call is not passed through RPP. In an embodiment, such a call requires the acceptance of charges by the originating caller, as discussed above. In an embodiment, such a call requires the acceptance of the portion of the charge or charge rate for the Receiving Leg exceeding the maximum, as also discussed above.

In an embodiment, the determination of the Roaming status of the customer's receiving device comprises a determination of the location of such device. In addition, the identification of the originating device may comprise identifying the telephone number of the originating device, where the originating device is a telephony device.

In an embodiment, video and/or data connections are established via the network instead of, or in addition to, telephone connections. Accordingly, video devices, data devices, network devices and/or adapters may be utilized instead of telephones. Further, web-based services may be implemented in addition to telephone calls. With regard to billing for connection charges, the charge may be based on a per-connection charge, such as a per-call charge, rather than a per-minute charge. In an embodiment, charge may be based on a minute-bank, e.g., pre-paid minutes.

While the invention has been particularly shown and described with reference to embodiments thereof, it will be understood by those skilled in the art that various changes in form and details may be made therein without departing from the spirit and scope of the invention. The above embodiments are illustrative of the present invention. It is neither necessary, nor intended for this patent to outline or define every possible combination or embodiment. The inventor has disclosed sufficient information to permit one skilled in the art to practice at least one embodiment of the invention, and has disclosed the ways the inventor now believes are the best ways to practice the invention. The variations to the present invention include variation in the services provided and the information transmitted.

What is claimed is:

1. A method for allowing calling-party-pays charging on roaming calls, comprising:
receiving, at a network, a request for an originating device to connect to a roaming device;
determining whether the roaming device is in a cellular local network or outside the cellular local network, wherein the roaming device is roaming only if the roaming device is outside the cellular local network;
if the roaming device is roaming outside the cellular local network:
determining from a database whether the originating device is in a list;
if the originating device is in the list, connecting the originating device and roaming device and billing the charge for the connection to the roaming device;
if the originating device is not in the list:
prompting a message to the originating device, wherein the message prompts the originating device to pay the charge for the connection;
if the originating device transmits an acceptance of the charge for the connection, connecting the originating device to the roaming device and billing the charge to the originating device; and
if the originating device rejects the charge for the connection, terminating the connection.

2. The method of claim 1, further comprising:
if the roaming device is not outside the cellular local network, connecting the originating device and roaming device and billing a charge for the connection to the originating device.

3. The method of claim 1, wherein the originating device is a telephony device, a video device, or a data device.

4. The method of claim 1, wherein detection of the request is performed at an IN System located on the network.

5. The method of claim 1, wherein the determination from a database is performed at an IN System located on the network.

6. The method of claim 1, wherein the prompting of the message to the originating device is performed via an IN System located on the network.

7. The method of claim 1, wherein billing of the charge for the connection is performed by an IN System located on the network.

8. The method of claim 1, wherein billing of the charge for the connection is performed by the roaming device.

9. The method of claim 1, further comprising of:
prompting a service to the originating device, wherein the service provides advertising, consulting, entertainment, or information.

10. A method for managing roaming charges for a mobile device, the method comprising the steps of:
receiving, at a network, a request for an originating device to connect with the mobile device;
determining a charge required to be accepted by the originating device to connect with the mobile device;
transmitting, from the network to the originating device, a request to accept the charge;
receiving, at the network, an acceptance of the charge;
completing the connection between the originating device and the mobile device; and
charging the charge to an account associated with the originating device.

11. The method of claim 10, wherein the originating device is a telephony device, a video device, or a data device.

12. The method of claim 10, wherein the charge is based on a unit-time for the connection.

13. The method of claim 10, wherein the charge based on a unit-time for the connection is a per-minute charge.

14. The method of claim 10, wherein the charge is a per-call charge.

15. The method of claim 10, wherein the charge is based on a minute bank.

16. The method of claim 10, wherein the request for an originating device to connect is generated by originating a phone call or web-based service.

17. The method of claim 10, wherein the request to accept the charge is presented at the originating telephony device as a voice prompt.

18. The method of claim 10, wherein the acceptance of the charge is a voice command.

19. The method of claim 10, wherein the acceptance of the charge is a short message service message (SMS message).

20. The method of claim 10, wherein the request to accept the charge is presented at the originating telephony device as a text prompt.

21. The method of claim 10, wherein the acceptance of the charge is a DTMF tone.

22. A method for managing roaming charges for a roaming customer telephony device, comprising the steps of:
identifying a contact telephony device attempting to establish a connection to a roaming customer telephony device, wherein the connection is at least partially wireless;
associating the contact telephony device with a contact entry stored in a database;
determining a roaming status of the roaming customer telephony device;
determining a service level associated with the contact entry;
providing the associated service level to the contact telephony device; and
providing the contact telephony device with an opportunity to accept or reject the connection based on the associated service level.

23. The method of claim 22, further comprising:
establishing a plurality of service levels for a plurality of connections between the roaming customer telephony device and a plurality of contact telephony devices, wherein the connections are at least partially wireless;
associating at least one of the plurality of service levels with at least one of the plurality of contact entries, wherein the at least one of the plurality of contact entries is associated with at least one of the plurality of contact telephony devices, wherein the at least one of the plurality of contact entries is stored in the database or memory; and
storing, in the database, the at least one of the plurality of service levels associated with the at least one of the plurality of contact entries.

24. The method of claim 23, further comprising:
associating a default service level with an unassociated contact telephony device, wherein the unassociated contact telephony device may be different from each of the plurality of contact entries stored in the database.

25. The method of claim 22, wherein the service level associated with the contact entry is associated with a CPP approach or a RPP approach.

26. The method of claim 22, further comprising:
selecting a cellular carrier having a predetermined service level for the connection based on the predetermined service level, wherein the predetermined service level is based on a cost associated with the connection.

27. The method of claim 22, further comprising:
billing an associate of the contact telephony device for at least a portion of a cost of the connection, wherein an associate of the roaming customer telephony device determines the at least a portion of the cost of the connection that is billed to the associate of the contact telephony device.

28. The method of claim 22, wherein the roaming customer telephony device is a cellular telephone.

29. The method of claim 22, wherein the contact telephony device is a cellular telephone.

30. The method of claim 22, wherein the connection is a telephone connection.

31. The method of claim 22, wherein the connection is a data connection.

32. The method of claim 22, wherein the contact entry is stored in an address book, and wherein the address book is stored on the roaming customer telephony device, a memory card in the roaming customer telephony device, a SIM card in the roaming customer telephony device, or a central database.

33. The method of claim 22, wherein the determining of the roaming status of the roaming customer telephony device comprises determining the location of the roaming customer telephony device.

34. The method of claim 22, wherein the identifying of the contact telephony device comprises identifying the telephone number of the contact telephony device, wherein the contact telephony device is a telephone or a network adapter.

35. A system for directing charges for connecting to a mobile device, the system implemented for use in a network adapted to accept incoming calls from an originating device that are directed to a telephone number, and to establish a connection between the originating device and a mobile device associated with the telephone number, the connection permitting bi-directional transmission of voice data between the originating device and the mobile device, the system comprising:
a pass list comprising at least one selected from the group of phone number, area code, contact identifier or search string;
a call transition module adapted to automatically establish a connection between the originating device and the mobile device if the originating device is identified on the pass list;
a presenter adapted to transmit a request to incur a charge to the originating device, and to receive a response to the request;
a switch adapted to establish a connection between the originating device and the mobile device where the presenter receives a response to the request that indicates acceptance of the charge;
a biller adapted to direct the charge to an account associated with the originating device.

36. The system of claim 35, where the charge is a roaming charge associated with establishing a call to the mobile device.

37. The system of claim 36, further comprising:
a charge determiner adapted to identify the charge required for a connection between the originating device and the mobile device.

38. The system of claim 37, where the request to incur a charges includes an indicia of the charge.

39. The system of claim 35, where the charge is a predetermined charge.

40. The system of claim 39, where the predetermined charge is a predetermined charge associated with the originating device.

41. The system of claim 39, where the predetermined charge is a predetermined charge associated with the mobile device.

42. A system for a redirecting a roaming charge for a mobile device, the system implemented for use in a network adapted to accept incoming calls from an originating device that are directed to a telephone number, and to establish a connection between the originating device and the mobile device associated with the telephone number, which mobile device is located outside its cellular local network, the connection permitting bi-directional transmission of voice data between the originating device and the mobile device, the system comprising:
a charge determiner adapted to quantify the mobile device roaming charge for a connection between the originating device and the mobile device, the mobile device roaming charge being a charge associated with the mobile device being located outside its cellular local network; and
a biller adapted to bill the mobile device roaming charge to the originating device's telephone number.

43. The system of claim 42, further comprising:
a presenter adapted to transmit a request to incur the mobile device roaming charge to the originating device, and to receive a response to the request; and
a switch adapted to establish a connection between the originating device and the mobile device where the presenter receives a response to the request that indicates acceptance of the charge by the originating device.

44. A system for a redirecting a roaming charge for a mobile device, the system implemented for use in connection with a network adapted to accept incoming calls from an originating device that are directed to a telephone number, and to establish a connection between the originating device and the mobile device associated with the telephone number, which mobile device is located outside its cellular local network, the connection permitting bi-directional transmission of voice data between the originating device and the mobile device, the system comprising:
a charge determiner adapted to quantify the mobile device roaming charge for a connection between the originating device and the mobile device, the mobile device roaming charge being a charge associated with the mobile device being located outside its cellular local network; and
a presenter adapted to present a request to incur the mobile device roaming charge to the originating device, and to receive a response to the request; and
a charge acceptor adapted to send an indication of an acceptance of the mobile device roaming charge to the network adapted to establish a connection between the originating device and the mobile device associated with the telephone number.

45. A method for directing roaming charges for a mobile device, the method comprising the steps of:
receiving, within a network, a request for a connection between an originating device and a mobile device;
determining a charge required for the connection between the network and the mobile device;
transmitting, from the network, in response to the request for the connection, a request to accept the required charge for the connection;
receiving, at the network, an acceptance of the required charge for the connection;
establishing the connection between the originating device and the mobile device; and
charging the charge to an account associated with acceptor of the required charge.

46. The method of claim 45 wherein the mobile device is a mobile telephony device and the roaming charges comprise roaming charges for an incoming call.

47. The method of claim 46, wherein the request to accept the required charge for the connection is directed to at least one of the originating device and the mobile device.

48. The method of claim 46, wherein the request to accept the required charge for the connection is directed to a third party.

49. The method of claim 45, wherein the request to accept the required charge includes presentation of the charge, and wherein the account associated with the acceptor is an account selected from the group consisting of an account associated with the originating device, an account associated with the mobile device, an account associated with the acceptor, or a third party account over which the acceptor is authorize to incur charges.
